(19) United States
(12) Patent Application Publication
(10) Pub. No.: US 2012/0076415 A1
(43) Pub. Date: Mar. 29, 2012

(54) COMPUTER AIDED VALIDATION OF PATENT DISCLOSURES

(76) Inventor: Michael R. Kahn, Cherry Hill, NJ (US)

(21) Appl. No.: 12/891,737

(22) Filed: Sep. 27, 2010

(51) Int. Cl. G06K 9/18; G06K 9/68

(52) U.S. Cl. 382/182; 382/218

(57) ABSTRACT

A method and system for analyzing a patent disclosure is disclosed. The method and system comprise a computerized cross-check of reference labels within drawings of a disclosure to reference labels found within the text of the disclosure, and generating warnings for reference labels that are missing from either the drawings or the text.

### FIELD OF THE INVENTION

The present invention relates to computerized analysis of patent disclosures. More particularly, the present invention relates to methods and apparatus for checking important details of the specification and claims of a patent disclosure.

### BACKGROUND

Writing a patent disclosure requires a lot of attention to detail. There are various opportunities for mistakes that cannot be identified with a traditional “spellchecker.” For example, in many cases, a word can be inadvertently misspelled as another valid word. Hence a spellchecker will not catch that. For example, if you misspell the word “tool” as “toll,” a spellchecker will not usually identify that error. These misspellings can often be identified from the context. However, when identifying elements of an invention in a patent disclosure, great care must be taken, since these terms may be subject to intense legal scrutiny if the patent should ever be involved in a court proceeding. In the aforementioned example of “tool” vs. “toll”, it may be possible to identify what is meant by the context. However, consider the case of typing “sulfite,” when what is meant is “sulfate.” Here, both terms are valid words, and refer to different chemical compounds. This is an example of a “typographical” error having potential legal repercussions. In addition to typographical mistakes, there are issues of proper support of claimed subject matter in the written description, and proper form of the claims in terms of claim numbering and antecedents. Even if these mistakes do not have any legal consequences, clients expect high quality from patent practitioners, and any mistakes may reflect badly upon the practitioner and/or firm. Therefore, what is desired is a system and method for computer aided validation of patent disclosures, to aid in prevention of filing patent applications that contain such mistakes. U.S. Patent Application Publication US20080147656 to Kahn, which is incorporated herein by reference, discloses a system and method for identifying cases such as these. However, that system does not include any means for checking for omitted or mislabeled drawing references. As patent drawings are a very important part of patents and patent applications, it is desirable to have a computer aided means for checking drawings against the written disclosure of a patent or patent application.

### SUMMARY OF THE INVENTION

Embodiments of the present invention provide important advantages for a patent practitioner (user). One advantage is the ability to identify reference numbers within drawings that are not mentioned in the written disclosure (‘specification’). These reference numbers are then brought to the attention of the user, allowing the user to determine if appropriate correction is required.

Another advantage is the ability to identify reference numbers within the written disclosure that are not present in a drawing.

### BRIEF DESCRIPTION OF THE DRAWINGS

In the drawings accompanying the description that follows, in some cases both reference numerals and legends (labels, text descriptions) may be used to identify elements. If legends are provided, they are intended merely as an aid to the reader, and should not in any way be interpreted as limiting.

FIG. 1 shows a high level flow diagram of a preferred method of using the present invention

FIG. 2 is a flow diagram showing additional details of drawing analysis method steps of an embodiment of the present invention.

FIG. 3 shows a symbolic view of extracting reference labels according to one embodiment of the present invention.

FIG. 4 shows a symbolic view of label filtering according to one embodiment of the present invention.

FIG. 5 shows a symbolic view of extracting reference labels according to an alternate embodiment of the present invention.

FIG. 6 shows an exemplary user interface for a drawing checking software application program in accordance with an embodiment of the present invention.

FIGS. 7 and 7B show block diagrams of a system in accordance with an embodiment of the present invention.

### DETAILED DESCRIPTION

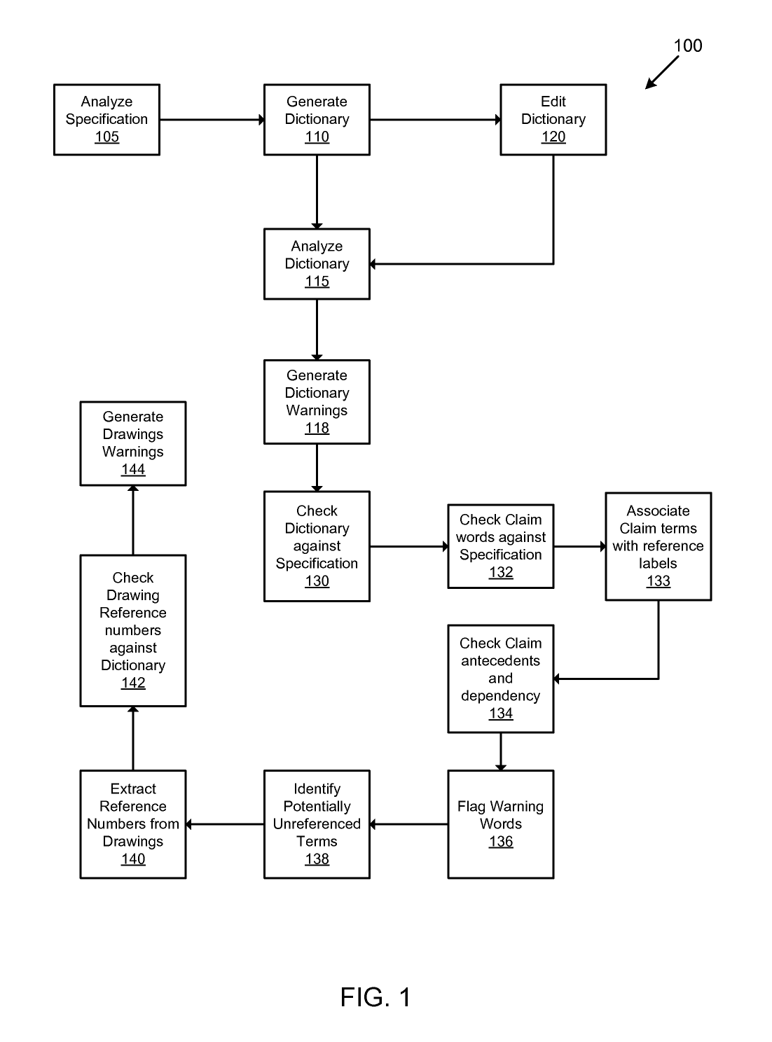

FIG. 1 shows a high level flow diagram 100 of a preferred method of using the present invention. In step 105, a specification (written description of an invention) is analyzed. Preferably, the specification file contains only a “detailed description” portion, with terms and corresponding labels following in the text. However, it is possible to practice the present invention using a full specification that includes the background, abstract, and other sections. However, the primary motivation of the tool is to assist in validating the detailed description, and confirm that properly refers to the references of the accompanying drawings. Hence, the results of the tools disclosed herein will be more relevant, if all of the text to be analyzed is relevant as well. In step 110 a dictionary is generated. The dictionary contains reference terms, followed by their corresponding labels. The dictionary is effectively a “parts list” including a list of terms and the corresponding reference label (e.g. the reference label could be a reference number or an alphanumeric label). These terms and labels are automatically extracted by parsing the specification.

It is possible that the dictionary that is automatically generated in step 105 contains some terms that should not be included in the dictionary, and may not include some that should be there. This can happen if the wording of the specification is unconventional, causing the terms to be misidentified during the automatic process. In step 120, the user is given the opportunity to edit the dictionary, adding and removing terms as they deem appropriate.

In step 115, the dictionary is analyzed, and any duplication of terms or labels results in a warning being issued for those terms and labels in step 118. The user may then repeat steps 120 and 115 as often as necessary, until the dictionary represents the complete list of terms and labels used in the specification. Alternatively, the user may skip the automatic dictionary generation step of 110, and provide their own dictionary that was generated from other means. For example, the user may compile a list of terms and labels in a spreadsheet as they write the specification. They can then import the data from the spreadsheet to a file that can be read by the various processes within a system of the present invention. It is a matter of preference, and there is no “right” or “wrong” way to obtain a dictionary file. Regardless of how the dictionary file is created, once it has been created, it is compared to the specification in step 130. This comparison comprises identifying terms in the specification, and the label that follows in the specification. The term is then looked up in the dictionary, and the list of labels used to refer to that term is retrieved. This list is compared with the label found in the specification. If there is no match, then a warning is generated and presented to the user, indicating that an incorrect or missing label may exist for the term.

In step 132, the claims are examined, and a list of words appearing in the claims is generated. This list is checked against the specification. Any word in the list that is not found generates a warning to the user. This alerts the user that a particular word found in the claim is not present in the detailed description. The user can then verify if the word used in the claim has been sufficiently defined in the application. As patents are legal documents, claim terms can be highly scrutinized should a patent undergo a legal test (e.g. in the CAFC court). Therefore, it is worthwhile for a patentee (or his/her practitioner) to conduct this analysis. The claim words may optionally be checked against the dictionary, to further qualify words in the claims that are not part of the dictionary.

In step 133, an association between a term in a claim, and its reference number given in the disclosure. This is possible since the dictionary has terms and the corresponding reference labels (e.g. a reference number).

In step 134, claims are checked for proper dependency, and antecedent basis. Dependent claims are identified, and claim terms are associated with a claim number. The present invention identifies “intro” terms and “stated” terms. Intro terms are those that are introduced with an indefinite article (such as ‘A’ or ‘An’). Stated terms are introduced with a definite article (such as ‘the’ or ‘said’). Stated terms within a claim are checked to see if they match a previously cited intro term. If no matching intro term is found, then a warning is generated to the user. The parent claim number is also checked to verify that it is a claim within the application, and that the claim numbering of the parent claim is lower than that of the claim. This can help catch a transposition error, such as writing the phrase “13. The method of claim 21 . . . ” instead of: “13. The method of claim 12 . . . ”

In step 136, warning words are identified to the user. These are words that tend to have limiting meanings, such as “must.” While these words may be appropriate in a patent application, caution is required when using limiting words to make sure that the invention is not being described in a too narrow scope. The user can then examine the instances of these words to verify that they are appropriate for the given context.

In step 138, potentially unreferenced terms are identified and presented to the user. This is accomplished by performing a linguistic analysis, looking for specific patterns that tend to be use when elements of an invention are stated. Phrases matching these patterns are identified, and the term from within these patterns is copied to a list of potential terms. Each item in the list of potential terms is checked against the dictionary. If there is a match found, then no warning is generated. If a match is not found, then this word is presented to the user and identified as a potentially unreferenced term. The user can then verify if the identified words should be referenced with reference numbers, and update the dictionary as needed.

In step 140, reference labels are extracted from associated drawings. In step 142 the reference labels are compared against those contained in the dictionary that is generated in step 110 (the dictionary is optionally edited in step 120). In step 144 warnings are generated for any reference labels that appear in either the drawings or the specification, but not both. These instances represent a potential omission or erroneous reference label. One such example is the common mistake of transposition, which is difficult to catch by manual checking.

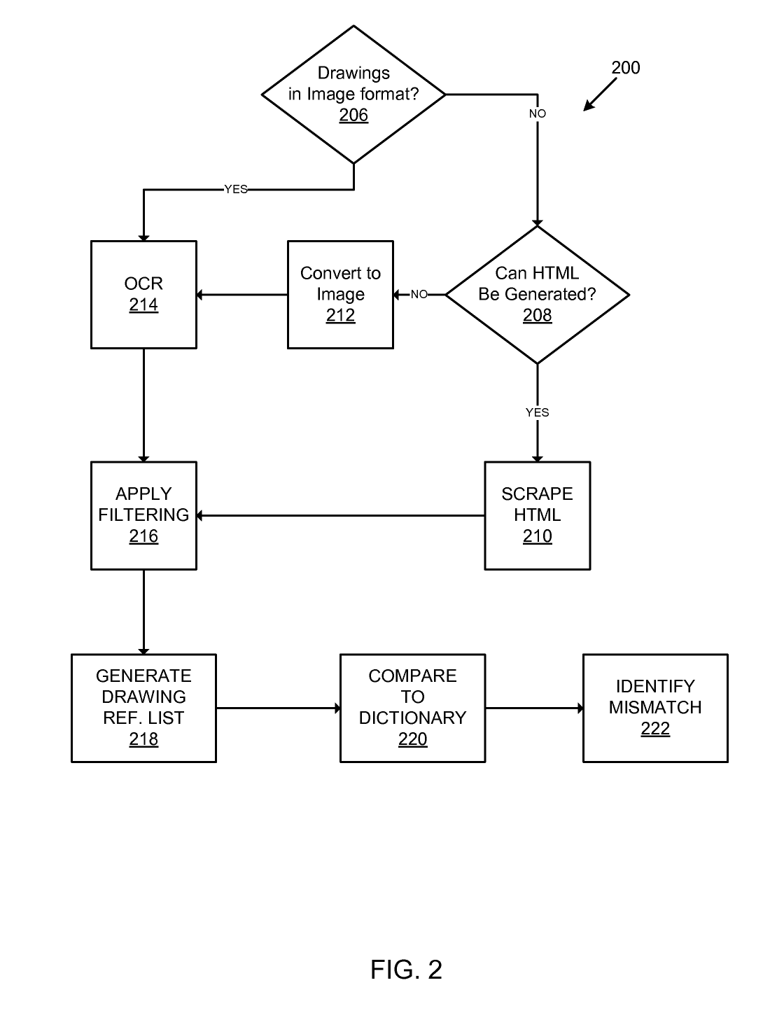

FIG. 2 is a flow diagram 200 showing additional details of drawing analysis method steps of an embodiment of the present invention. In step 206 the drawings are checked to determine if they are in an image format. Image formats may include, but are not limited to, TIFF, JPEG, PNG, and BMP. If the drawings are in an image format then an optical character recognition (OCR) process is performed in step 214 to convert reference labels to text. Unlike OCR of text of a book, the text within a patent drawing (or disclosure drawing) is typically quite sparse. Furthermore, as common practices favor the use of numbers to letters, the OCR is preferably weighted to favor resolving to a number as opposed to a letter. For example, a character may be favored as a “9” rather than a “g.” By skewing the OCR matches to favor numbers, the results are better suited to what is typically used in patent drawings. The output of the OCR process 214 is a tokenized list of text strings that were identified upon analysis of the drawings.

In step 216, filtering is applied to the drawing text extracted in the OCR process of step 214. The filtering may include eliminating tokens exceeding a predetermined length. For example, disclosure reference labels are usually 5 characters or less, and usually are alphanumeric. Therefore, the filtering step 216 may remove strings that exceed 5 characters, and those strings that have mathematical symbols within them (e.g. ‘+’, ‘−’, ‘%’, etc. . . . ).

In step 218, the output of the filtered list is stored in a drawing reference list. In step 220, the drawing reference list is compared to the reference list of the dictionary. In step 222, any reference labels that are not found in both the written specification, and the drawing list are flagged, and a warning is presented to the user, indicating the reference label, and where that reference label is found and where it is missing. If, at step 206, it is determined that the drawings are not in an image format, then a check is made at step 208 to determine if a markup representation, such as HTML can be generated. If so, then the HTML generated and scraped in step 210, and the filtering is then applied as previously described for step 216. If HTML cannot be generated in step 208, then the drawings are converted to an image format in step 212, and then proceed to the OCR process 214 as previously described.

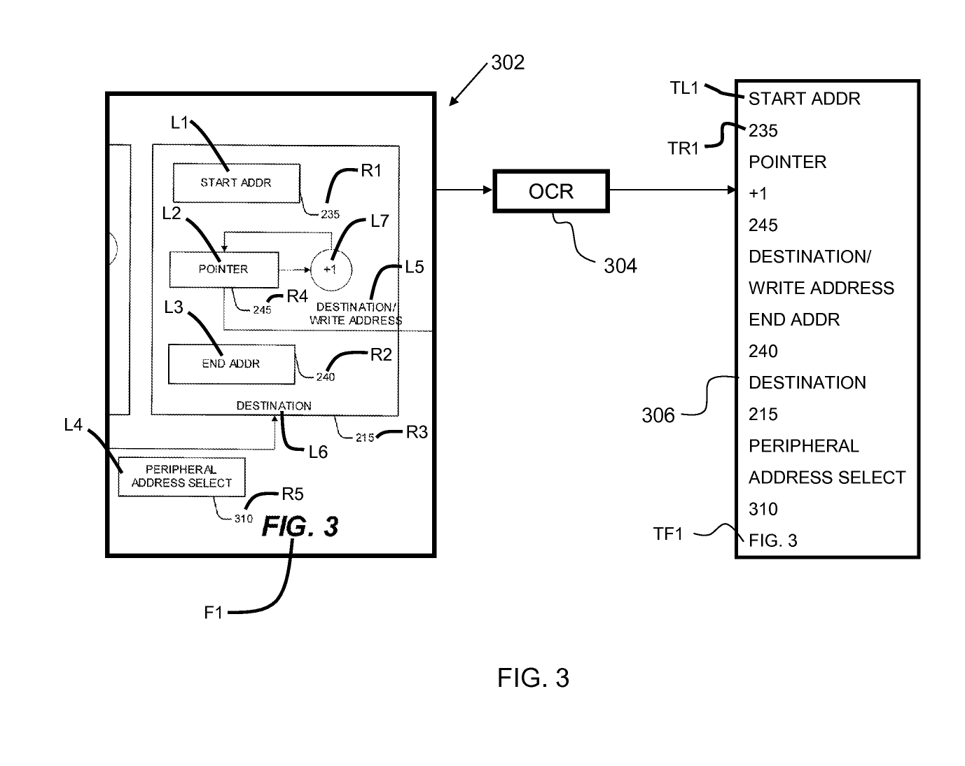

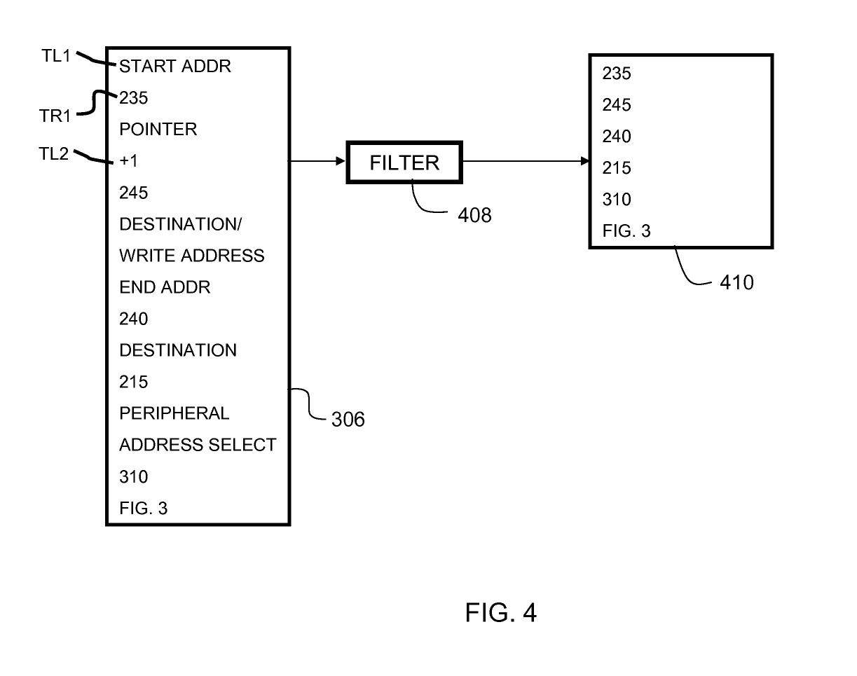

FIG. 3 shows a symbolic view of extracting reference labels according to one embodiment of the present invention. An OCR process 304 is performed on patent drawing 302, and the output of the OCR process 304 is a tokenized list 306. Note that only a portion of the drawing is illustrated in reference 302. To avoid confusion between reference labels that are part of the disclosure and those that belong to drawing 302 itself, alphanumeric labels are used as part of this disclosure. For example the label R1 refers to the number “235” which is part of the drawing 302. The label R1 (and all labels with the format of RX, LX, or FX, where X is a number) is not part of the drawing 302. Furthermore, the lead lines for the reference labels that are part of the disclosure are drawn thicker than those that are part of the drawing itself.

As part of the OCR process, the text within drawing 302 is converted and placed in tokenized list 302. For example, L1 (‘start addr’) in drawing 302 is represented as TL1 in list 306. R1 (‘235’) is represented as TR1 in list 306. The text of the figure number itself (F1) is also included in list 306 as TF1. Since the figure number is often found at the bottom of the drawing, it can be identified and used to help further identify the location of an unresolved reference label. For example, all the tokens in list 306 shown can be associated with FIG. 3. Then, if upon comparison with the specification, the reference label TR1 (‘235’) is not found within the specification, the user can receive a warning that identifies the label (‘235’) as well as the figure (TF1=‘FIG. 3’) where the label appears, which can aid the user in identifying the figure that needs to be verified against the specification.

FIG. 4 shows a symbolic view of label filtering according to one embodiment of the present invention. Filter 408 is applied to list 306, and the output of filter 408 is reference list 410. In one embodiment, the filtering removes strings that exceed 5 characters, and those strings that have mathematical symbols within them (e.g. ‘+’, ‘−’, ‘%’, etc. . . . ). As shown in FIG. 4, item TL1 (‘start addr’) is filtered out, and is not present in reference list 410. Item TR1 (‘235’) meets the filter criteria of being 5 characters or less in length, and having no mathematical symbols, and hence is present in reference list 410. Item TL2 (‘−1’) is 5 characters or less in length, but does have a mathematical operator symbol (‘plus sign’) and thus, is filtered out, and is not present in reference list 410. In one embodiment of the present invention, the user is provided with the ability to edit reference list 410 to add, remove, or edit entries in the list to compensate for any errors in OCR, or for any item that was incorrectly filtered. Other symbols causing an item to get filtered may include, but are not limited to, “! (exclamation), @ (at), # (pound), $ (dollar), % (percent), ̂ (carat), & (ampersand), <(less than), * (asterisk), > (greater than)”

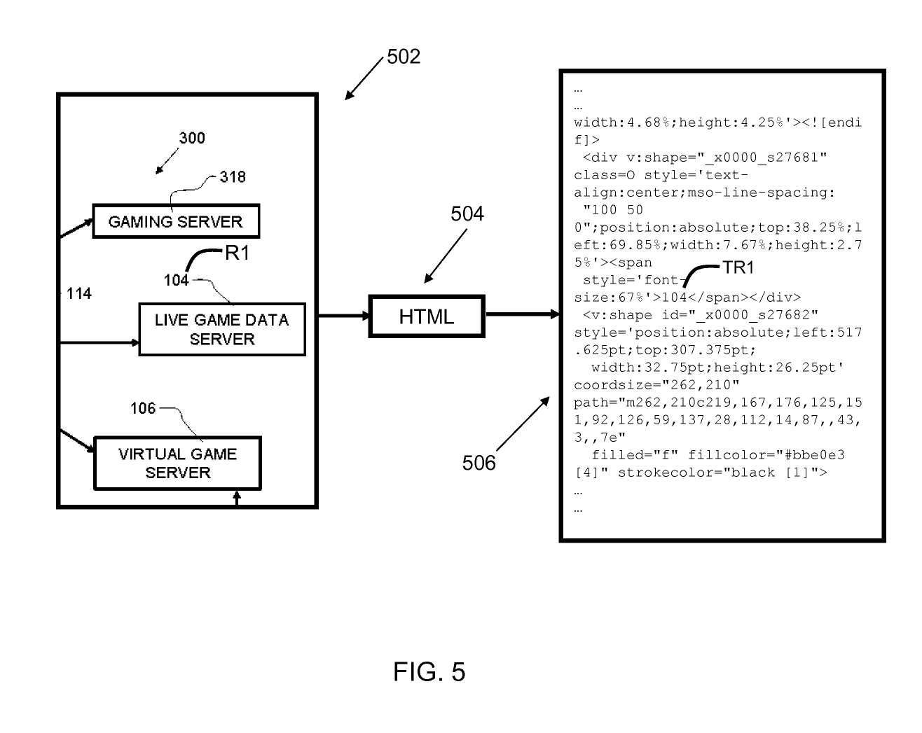

FIG. 5 shows a symbolic view of extracting reference labels according to an alternate embodiment of the present invention. Since various drawing packages have a feature to export drawings to HTML, embodiments of the present invention make use of this to extract reference labels directly from HTML. By using HTML, OCR is avoided, and thus, errors associated with OCR, are also avoided.

As shown in FIG. 5, drawing 502 is converted to HTML by HTML converter 504, resulting in HTML page 506. A scraper program, implemented with machine instructions on computer-readable medium reads the HTML and “scrapes” the reference labels from the HTML page. The same filtering as described previously (see filter 408 of FIG. 4) can be used to filter the strings that are scraped from the HTML page 504. For example, reference R1 is drawing 502 points to element ‘102,’ which correlates to reference TR1 in HTML page 504.

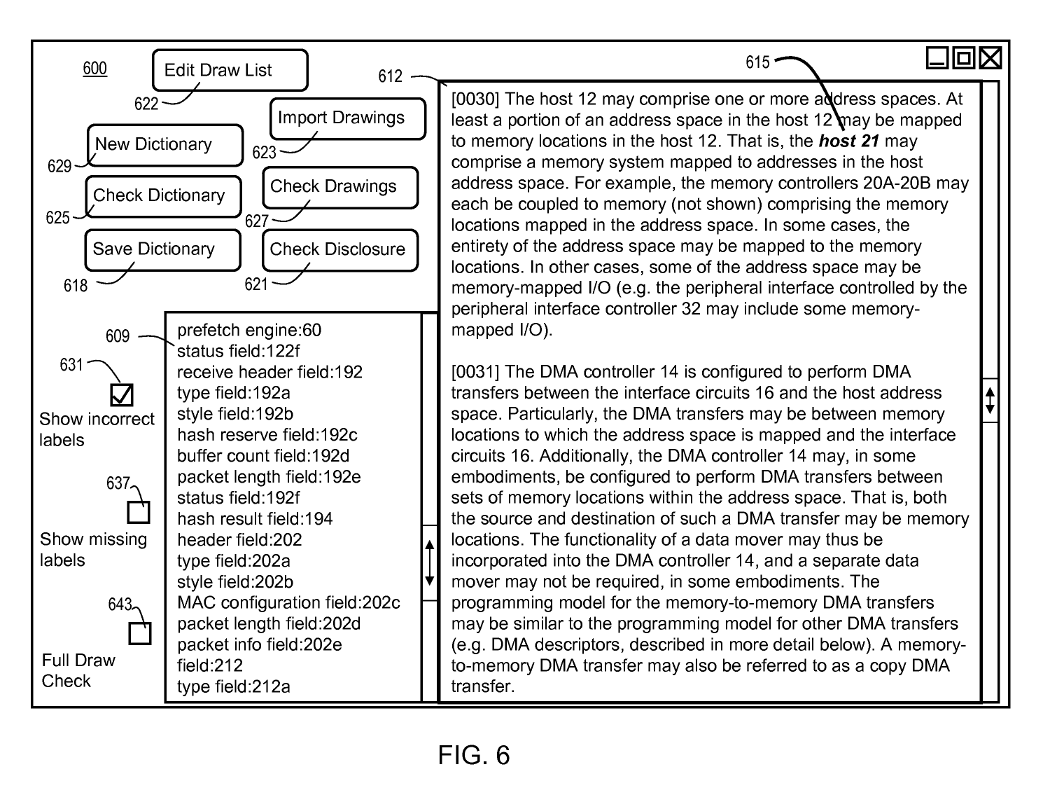

FIG. 6 shows an exemplary user interface 600 for a drawing checking software application program in accordance with an embodiment of the present invention. User interface 600 comprises editable text window 609 that lists a dictionary file, which contains tuples, wherein each tuple includes a term, and the corresponding reference label. Text window 612 may be implemented as either editable or non-editable, and displays the specification of the patent application under analysis. Discrepancies found may be indicated via a visual differentiation, such as text in another color, or, as indicated by reference 615, text that is highlighted in bold. In this case, since the term “host” appears in most places within the specification with a reference number of 12. Therefore, the occurrence of “host” with a reference label of “21” is flagged as a possible mistake. User control 629 causes a new dictionary to be generated when invoked. This refreshes the display in window 609. The dictionary can then be edited by directly editing the text in window 609. The edited dictionary can be saved by invoking user control 618. User control 625 invokes a feature to check the dictionary. This feature provides an identification of all terms that are referred to by multiple reference labels, and all reference labels that are used to refer to more than one term. Often, checking the dictionary can catch many mistakes early in the inspection process. User control 621 causes the disclosure to be checked against the dictionary in window 609 when invoked. This causes the text in window 612 to be updated, and any discrepancies are indicated (as in the case with reference 915, where bold italic text is used). Option 631 is shown as invoked in FIG. 6. This option indicates that incorrect labels are to be indicated in window 612. Option 637, shown as not checked in FIG. 6, is used to show missing labels, in which instances of words identified as belonging to the dictionary shown in window 609, that are not followed by a reference label in window 612, will be flagged, and a visual indication will be used to highlight those instances.

User control 623 causes a set of drawings to be imported. This process comprises extracting text (via OCR or HTML scraping) and filtering the extracted text to form a list of reference labels. User control 622 invokes a standard editable text window (not shown) which presents the list of reference labels that were found in the drawings allows a user to edit, add, and delete drawing references as necessary. User control 621 causes the drawing references to be checked against the dictionary that is derived from the specification. Any reference labels that are not present in both the drawing reference list (see 410 of FIG. 4) and the dictionary (see step 110 of FIG. 1) are presented to the user in the form of a warning. In one embodiment, if the reference label is present in the drawing reference list, but not in the dictionary, then the figure number is also presented to the user by identifying the subsequent “fig” string that follows the reference label in question. For example, in FIG. 3, reference TF1 in list 306 refers to “FIG. 3.” In this case, if reference TR1 (‘235’) is not present in the dictionary, then the warning to the user may appear as:

WARNING: Reference 235 from FIG. 3 not found in dictionary!

Option 643, shown as not checked in FIG. 6, is used to perform a check of the drawing references against the full specification, rather than just the dictionary. The dictionary processing contains logic to filter out numbers that are not likely to be reference numbers, such as dates and temperatures. Checking against the dictionary reduces the risk of falsely detecting a match between drawing and specification when a problem really exists. However, it is also possible to check against the full specification, in the event that the dictionary processing erroneously filtered out a valid reference. This feature therefore provides an extra level of confirmation that the drawing labels agree with the specification. In contemplated usage, a user may check the drawings twice: first against the dictionary, and second, against the entire specification. A similar graphical warning mechanism may be employed for reference numbers found in the specification that are not present in the drawings. For example, referring again to FIG. 6, if the reference number “21” is not found in the drawings, then the error indicated as 615 in FIG. 6 is presented to the user by bold and/or colored text, indicating a mismatch between the specification of the disclosure and the drawings.

In another embodiment of the present invention, the associated reference labels of claim terms, obtained in step 133 (FIG. 1) are checked against the list of drawing references. Any claim terms that do not have a corresponding reference number are flagged as potentially not having adequate disclosure in the drawings.

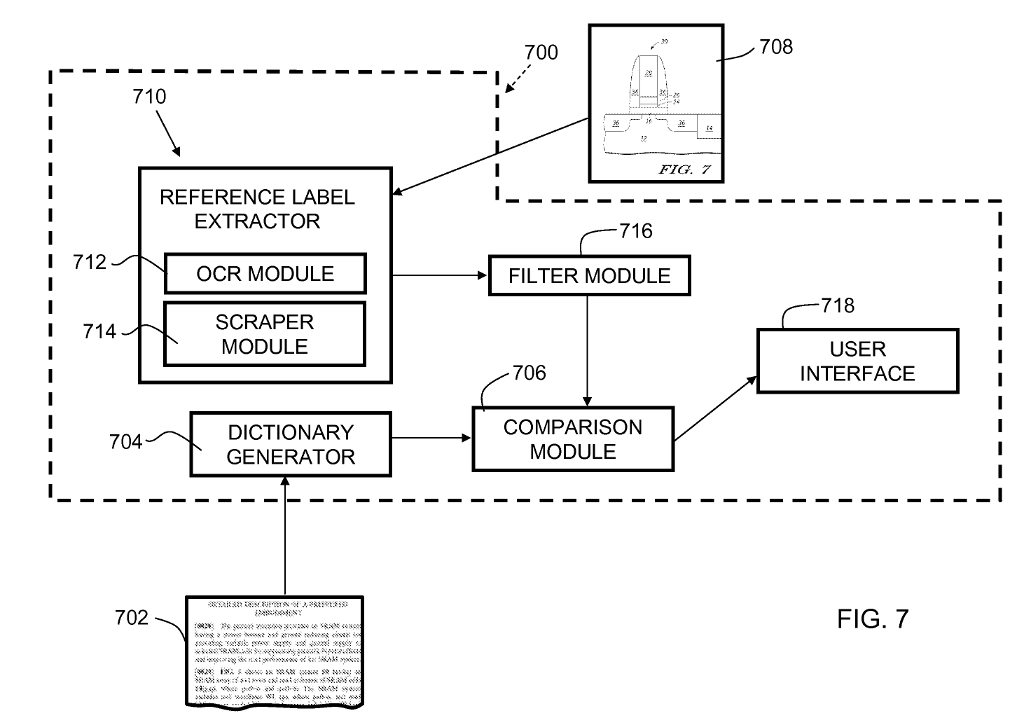

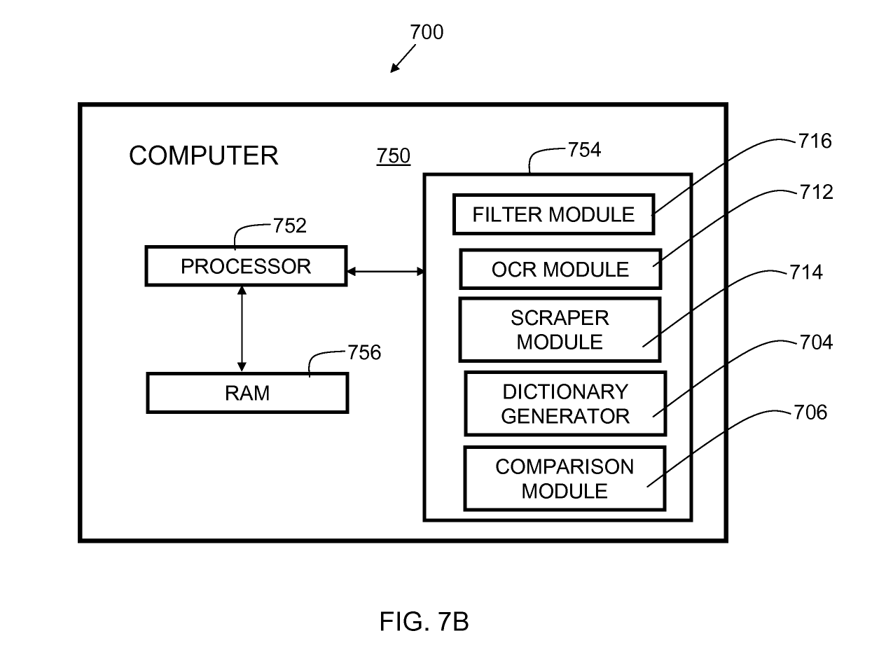

FIG. 7 shows a block diagram of a system 700 in accordance with an embodiment of the present invention. System 700 comprises reference label extractor 710 which comprises OCR module 712 for performing optical character recognition on drawings 708 in graphical format. Drawing may be stored, for example, in TIFF format, JPEG format, or bitmap format, to name a few. The OCR module 712 extracts text from these drawings. Scraper module 714 is used for “scraping” (extracting) text from drawings that are in a markup language format, such as HTML. For example, many drawing programs (e.g. Powerpoint by MICROSOFT Corporation, Redmond Wash.) allow exporting drawings in HTML format, as one or more HTML files. The scraper module 714 extracts text from these HTML files. The benefit of using a scraper is that it tends to be more accurate than OCR. The benefit of OCR is that it enables importing of drawings that are not available in a markup language. Filter module 716 receives text from reference label extractor 710 and filters out certain tokens that are not likely to be reference labels, such as lengthy strings (e.g. over 6 characters) or strings comprising symbols.

Dictionary generator 704 extracts reference labels from a patent disclosure 702 and provides the reference labels to comparison module 706. Comparison module 706 compares two sets of data, the reference labels from the disclosure, and the reference labels from the drawings. If there are any data in one set that is not in the other set, then a warning is issued to user interface 718, which typically comprises a computer display, such as a LCD monitor.

FIG. 7B shows a block diagram of a system 700 in accordance with an embodiment of the present invention, indicating hardware components. System 700 comprises a computer 750 which comprises a processor 752, non-volatile memory 754, and RAM 756. While not shown, computer 750 may also comprise other elements, such as monitor, user input devices (keyboards, mouse, and the like), as is well-known in the industry.

Non-volatile memory 754 contains instructions, that when executed by processor 752, implement the filter module 716, OCR module 712, scraper module 714, dictionary generator 704, and comparison module 706.

As can be appreciated, the above disclosed system and method provide for improved computer aided validation of patent disclosures. The present invention provides an author of a patent disclosure with a powerful set of tools and methods for quickly checking important information within a patent disclosure. In particular, the ability to identify terms that have not been assigned a reference label, yet may be important to the description of the invention is a very useful feature for a disclosure writer and/or practitioner. Furthermore, the ability to edit the claim elements prior to analysis combines the advantages of the speed and processing power of a computerized, automated system, with the benefits of human analysis, that in some cases, can quickly identify contextual issues that purely automated software solutions often miss. The result is a system that can quickly and accurately identify many types of flaws within a patent disclosure.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given

What is claimed is:

1. A method for checking the accuracy of drawings associated with a patent disclosure, comprising the steps of:
extracting reference labels from said drawings, whereby a drawing reference label list is created;
generating a dictionary from the patent disclosure, wherein the dictionary comprises a plurality of tuples, wherein each tuple contains a reference term and a corresponding dictionary reference label;
comparing each entry in the drawing reference label list to the contents of dictionary; and
generating a warning if a drawing reference label is not found in the dictionary, or a dictionary reference label is not found in the drawing reference label list.

2. The method of claim 1, wherein the step of extracting reference labels from said drawings comprises performing optical character recognition on said drawings.

3. The method of claim 2, further comprising the step of filtering reference labels comprised six or more characters.

4. The method of claim 3, further comprising the step of filtering reference labels comprised of a mathematical operator symbol.

5. The method of claim 1, wherein the step of extracting reference labels from said drawings comprises:
converting the drawings to an HTML format, whereby one or more HTML pages are created;
scraping said HTML pages, whereby each reference label is stored in a drawing reference label list.

6. The method of claim 5, further comprising the step of filtering reference labels comprised six or more characters.

7. The method of claim 6 further comprising the step of filtering reference labels comprised of a symbol.

8. The method of claim 7 further comprising the step of filtering reference labels comprised of a mathematical operator symbol.

9. The method of claim 1, further comprising the step of generating a warning if a claim term does not exist in the plurality of tuples.

10. A system for checking the accuracy of drawings associated with a patent disclosure, comprising:
means for extracting reference labels from said drawings, whereby a drawing reference label list is created;
means for generating a dictionary from the patent disclosure, wherein the dictionary comprises a plurality of tuples, wherein each tuple contains a reference term and a corresponding dictionary reference label;
means for comparing each entry in the drawing reference label list to the contents of dictionary; and
means for generating a warning if a drawing reference label is not found in the dictionary, or a dictionary reference label is not found in the drawing reference label list.

11. The system of claim 10, wherein the means for extracting reference labels from said drawings comprises an optical character recognition module.

12. The system of claim 10, wherein the means for extracting reference labels from said drawings comprises an HTML scraper module.

13. A system for checking the accuracy of drawings associated with a patent disclosure, comprising a computer, the computer comprising a processor, and non-volatile memory containing machine-readable instructions, that when executed by said processor, perform the steps of:
extracting reference labels from said drawings, whereby a drawing reference label list is created;
generating a dictionary from the patent disclosure, wherein the dictionary comprises a plurality of tuples, wherein each tuple contains a reference term and a corresponding dictionary reference label;
comparing each entry in the drawing reference label list to the contents of dictionary; and
generating a warning if a drawing reference label is not found in the dictionary, or a dictionary reference label is not found in the drawing reference label list.

14. The system of claim 13, wherein the non-volatile memory further contains machine-readable instructions, that when executed by said processor, performs optical character recognition on said drawings.

15. The system of claim 13, wherein the non-volatile memory further contains machine-readable instructions, that when executed by said processor, performs the steps of:
converting the drawings to an HTML format, whereby one or more HTML pages are created;
scraping said HTML pages, whereby each reference label is stored in a drawing reference label list.

16. The system of claim 13, wherein the non-volatile memory further contains machine-readable instructions, that when executed by said processor, performs the step of filtering reference labels comprised six or more characters.

17. The system of claim 13, wherein the non-volatile memory further contains machine-readable instructions, that when executed by said processor, performs the step of filtering reference labels comprised of a symbol.

18. The system of claim 13, wherein the non-volatile memory further contains machine-readable instructions, that when executed by said processor, performs the step of filtering reference labels comprised of a mathematical operator symbol.

19. The system of claim 13, wherein the non-volatile memory further contains machine-readable instructions, that when executed by said processor, performs the steps of:
extracting a plurality of claim terms from claims of a patent disclosure; and
generating a warning if a claim term does not exist in the plurality of tuples.

20. The system of claim 13, wherein the non-volatile memory further contains machine-readable instructions, that when executed by said processor, performs the steps of:
presenting a term and reference number from the specification in bold typeface when the reference number is absent from the drawing reference label list.
